(19) United States
(12) Patent Application Publication
(10) Pub. No.: US 2011/0034246 A1
(43) Pub. Date: Feb. 10, 2011

(54) SYSTEM AND METHOD FOR A TWO DIMENSIONAL TO THREE DIMENSIONAL GAME TRANSFORMATION

(76) Inventor: Eyal Amitzur, Tel-Aviv (IL)

Correspondence Address: DR. D. GRAESER LTD., 9003 FLORIN WAY, UPPER MARLBORO, MD, 20772, US

(21) Appl. No.: 12/937,265

(22) PCT Filed: Apr. 5, 2009
(86) PCT No.: PCT/IL09/00377

§ 371 Date: Oct. 19, 2010

Related U.S. Application Data
(60) Provisional application No. 61/071,021, filed on Apr. 9, 2008.

(51) Int. Cl. A63F 13/00; A63F 9/24

(52) U.S. Cl. 463/32; 463/42

(57) ABSTRACT

The present invention relates to a system and a method for generating three dimensional games or puzzles and in particular, to such a system and method in which two dimensional games or puzzle are converted into three dimensional versions of the same game or puzzle.

### FIELD OF THE INVENTION

The present invention relates to a system and a method for generating three dimensional games and in particular, to such a system and method in which two dimensional games are converted into three dimensional versions of the same game.

### BACKGROUND OF THE INVENTION

There are a wide range of traditional board games and paper-based puzzles that are currently played within or on, a well defined two dimensional (2D) playing surface, for example, sudoku, crossword, word search, chess, bingo, dominos and kakuro. Similarly, other games such as mahjong are conventionally played in a stacked two dimensional space giving the illusion of three dimensional play (3D). Although computerized versions of such 2D games and puzzles are available they have remained essentially within the realm of a 2D playing surface and do not offer a further challenge to the player. Some of these games have been made available in three dimensional space (3D). However, such attempts have merely created alleged three dimensional (3D) space wherein the games fail to provide a true 3D environment or playing surface. The primary drawback of these attempts is found in that the playing surface is displayed “as if” in 3D space.

Traditional 2D games and/or puzzles utilize a playing surface usually viewed by the player from a single trajectory of view, for example a top-down, up-down, or face-on views of a playing surface depending on game type or surface. For example, table-top games such as chess, dominos, or checkers are generally viewed from the top-down trajectory. For example, games or puzzles such as sudoku, word search, crosswords that are primarily paper based may be played while lying down offering a down-up trajectory of the playing surface. For example, some of these games played on a computer screen or display offer only the face-on trajectory. The various computerized implementation of these games do not offer any variation of the playing surface trajectory beyond that offered by the conventional game trajectory wherein the playing surface trajectory is changed either by player choice or as part of a dynamic experience of the game.

### SUMMARY OF THE INVENTION

There is an unmet need for, and it would be highly useful to have, a system and a method for converting traditional planar games, puzzles and playing surfaces into a three dimensional (3D) game while accounting for and maintaining core game components.

The term game within the context of the instant invention refers to any game, playing surface or puzzle.

Within the context of the present invention the term two dimensional is interchangeably with the term “2D”.

Within the context of the present invention the term three dimensional is interchangeably with the term “3D”.

Within the context of this application a 2D game optionally refers to any planar game, playing surface or puzzle optionally played on at least one or more 2D planes, optionally including games comprising a plurality of stacked or otherwise linked 2D surfaces.

The terms game pieces within the context of the instant invention refers to any game pieces, counters, cards, chips, alphanumeric characters, geometric shapes, characters, symbols or the like means for playing a game or means to convey a move within the context of the game. For example, a move may comprise placing a “piece” (optionally an alphanumeric character) in a designated area or “cell” of the playing surface, as in a crossword puzzle or sudoku.

The term player and or user within the context of the instant invention refers to at least one or more person, computer or server that is playing a game.

The term game or traditional 2D game within the context of the instant invention for example includes but is not limited to sudoku, kakuro, checkers, crossword, word jumble, word search, tic-tac-toe, chess, dominos, puzzles, memory, backgammon, bingo, Go, Match 3, Mahjong, Chinese Mahjong or the like.

Within the context of the instant invention the terms “open end” and/or “open ended” game and/or playing surface refers to a game and/or playing surface wherein the playing surface is preferably and optionally interactive allowing a user to continuously build on an initial playing surface. Optionally and preferably the playing surface characteristics for example dimension, angles, size and/or shape are not predetermined rather are dynamic and controllable. Optionally dynamic control and determination of the playing surface may be controlled by a user and/or controller. Most preferably an open ended playing surface and/or game provides for an interactive, controllable, and difficult or complicated playing surface defining a game. Optionally an open ended playing surface and/or game may be played wherein the playing surface grows in size and/ or decreases. For example, a growing open ended game is provided with an initial playing surface that grows and/or increase as the game progresses. For example, a decreasing open ended game may be start with a large playing surface and dynamically decrease in size as the game progresses. Optionally a decreasing open ended game could be played with a challenge and/or target of reaching a particularly shaped playing surface.

Within the context of the instant invention the term “close ended” and/or “closed ended” and/or “close end” game and/or playing surface refers to a game and/or playing surface wherein the playing surface characteristics and/parameters are determined at the onset of the game and do not change as the game processes. Optionally a close ended game and/or playing surface may be referred to as a static playing field.

The present invention overcomes the deficiencies of the background art by providing a system and method for converting a traditional planar game to a 3D game. An optional embodiment of the present invention provides for a multilevel transformation of the games by breaking the game down to its elemental pieces or core components and then rebuilding the game in the 3D realm or space. Optionally, the transformation process comprises transformation of the game playing surface. Optionally and more preferably, the transformation process comprises transformation of game rules, scoring system, and playing surfaces to individually undergo a 2D to 3D transformation process. Most preferably, the transformation process comprises transformation of game pieces, game rules, playing surfaces, and scoring scheme to individually undergo a 2D to 3D transformation. Optionally, the transformation process comprises transformation of game pieces, game rules, playing surfaces, and scoring scheme to undergo a unified 2D to 3D transformation.

Optionally, the 2D to 3D transformation according to an optional embodiment of the present may be implemented on any individual game aspects for example comprising: rules, scoring schemes, game pieces, playing surface. Optionally, the 2D to 3D transformation may optionally be undertaken on at least a combination of at least two or more game aspects for example comprising: rules, scoring schemes, game pieces, playing surface. Preferably, the 2D to 3D transformation may optionally be undertaken on a plurality of game aspects for example comprising: rules, scoring schemes, game pieces, playing surface in any combination thereof.

An optional embodiment provides for a 2D to 3D transformation comprising a plurality of smaller, core component transformations that are preferably later integrated to form a 3D game. Optionally and preferably the 3D transformation may optionally comprise a single step transformation not requiring further integration.

Optionally the transformation process according to an optional embodiment of the present invention provides for transformation of 2D games to their 3D equivalent, of games for example including but not limited to sudoku, word search, crossword, dominos, chess, checkers backgammon, kakuro, word jumble, memory games, bingo, Go, Match 3, Mahjong, Chinese Mahjong or the like.

An optional embodiment of the present invention provides for a truer 3D representation of the playing surfaces, preferably further provides a user optional trajectories by which the game may be played.

Optionally, the system and method of an optional embodiment of the present invention provides for generating open ended 3D games based on traditional 2D games.

Optionally, the system and method of an optional embodiment of the present invention provides for incorporating user defined components and variations preferably producing a customized 3D game.

Optionally, the system and method of an optional embodiment of the present invention provides for generating new 3D games based on combining a plurality of traditional 2D games to create unique 3D games. Optionally, and preferably a 3D game may be defined by a user based on choosing the plurality of 2D games.

An optional embodiment of the present invention provides for a transformation of a defined universe of games and puzzles from a 2D playing surface into 3D by comprising:

(i) adapting the game's/puzzle's rules to the opportunities and the constraints of 3D space; and

(ii) the adaptation, for at least one or more of the games, of the playing pieces into 3D pieces and counters.

Optionally the added dimension to the playing piece or counter would add further complexity to the 3D version or adaptation of the original 2D game.

Optionally and preferably a 3D game generated according to an optional embodiment of the present invention provides for delivery of these transformed games in various formats that may be optionally implemented by software or hardware. An optional embodiment of the present invention provides for the transformation of the generated 3D game to be outputted to at least one or more of a computer readable memory, a computer display device, a computer on a network, a printout, or user. For example a generated 3D game may optionally be implemented on a plurality of mediums comprising a processor for example including but not limited to a network computer, server, PDA, mobile telephone, printer, display, game console, or the like. For example the generated 3D game may optionally be implemented on a printed matter for example including but not limited to board games, puzzles, books, paper, magazines, newsprint or the like printed matter as is known and accepted in the art.

An optional embodiment of the present invention provides for a generated 3D game according to an optional embodiment of the present invention comprising a dynamic experience wherein optionally the user's viewing trajectory is toggled through the course of the game. Optionally, viewing trajectory may be controllably depicted either automatically by the game and/or manually by a user and/or by a third party controller or user.

Optionally, the system of the present invention may optionally be implemented on a server connected to at least one and more preferably a plurality of clients through a network connection for example including but not limited to an internet connection, intranet connection. Optionally, the server generates the game and distributes it to a plurality of clients optionally by network communication for example including but not limited to optical, wireless, wired, RF, cellular, markup language, http, xml, or the like communication protocols as is known and accepted in the art.

Optionally, the system according to an optional embodiment of the present invention provides for a social network wherein a plurality of users may interact exchanging games, ideas, upload, download, create new 3D games according to the present invention.

Optionally, the system and method of the present invention may be implemented on a plurality of electronic mediums comprising a display and processor for example including but not limited to a PDA, server, computer, mobile telephone or the like.

Optionally, the game according to an optional embodiment of the present invention may be played individually or with at least one or more players. Optionally, a plurality of players may play the game against one another. Optionally at least one or more players may play with one another. Optionally, at least one or more players may play as a team preferably against at least one or more team or player.

Unless otherwise defined the various embodiments of the present invention may be provided to an end user in a plurality of formats, platforms, and may be outputted to at least one of a computer readable memory, a computer display device, a printout, print media, digital media display, touch-screens, digital display device, game console, LCD, a computer on a network or a user.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone a PDA (personal data assistant), a pager, Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A-D are schematic block diagrams of traditional 2D games boards.

FIGS. 2A-I are schematic block diagrams of traditional 2D games boards depicting the game rules and optional directionality of play.

FIGS. 3A-E are schematic block diagrams of optional 2D games and their directionality of play.

FIG. 4A-D are schematic block diagrams of an optional 2D to 3D transformations according to the present invention.

FIG. 5 is a schematic block diagram of an optional 2D to 3D transformation according to the present invention.

FIGS. 6A-D are schematic block diagrams of exemplary 3D games produced by an optional embodiment of the present invention.

FIG. 7A-B are schematic block diagrams of optional 2D to 3D transformation according to the present invention.

FIG. 8A are schematic block diagrams of optional 2D to 3D transformation according to the present invention.

FIGS. 8B-G are schematic block diagrams of exemplary 3D games produced by an optional embodiment of the present invention.

FIG. 9 is a schematic block diagram of exemplary 3D games produced by an optional embodiment of the present invention.

FIG. 10A-B are exemplary method according to the present invention.

FIG. 11A-B are exemplary system according to the present invention.

### DESCRIPTION OF THE PREFERRED EMBODIMENTS

The present invention overcomes the deficiencies of the background art by providing a system and method for converting a traditional planar game 2D to a 3D game. An optional embodiment of the present invention provides for a multilevel transformation of the games by breaking the game down to its elemental pieces or core components and then rebuilding the game in the 3D realm or space. Optionally, the transformation process comprises transformation of the game playing surface. Optionally and more preferably, the transformation process comprises transformation of game rules, scoring system, and playing surfaces to individually undergo a 2D to 3D transformation process. Most preferably, the transformation process comprises transformation of game pieces, game rules, playing surfaces, and scoring scheme to individually undergo a 2D to 3D transformation. Optionally, the transformation process comprises transformation of game pieces, game rules, playing surfaces, and scoring scheme to undergo a seamless and coherent 2D to 3D transformation.

The principles and operation of the present invention may be better understood with reference to the drawings and the accompanying description.

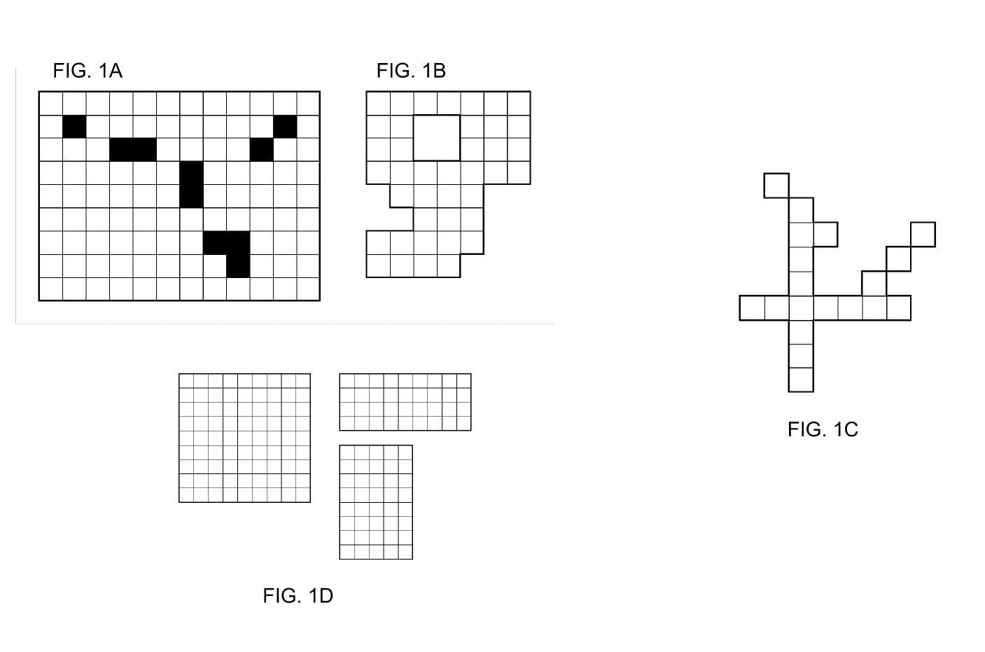

FIGS. 1A to 1D illustrate examples of 2D games that may be transformed to 3D space according an optional embodiment of a method and system of the present invention. FIG. 1A-1C are optional crossword puzzle formations known in the art that optionally may be transformed to 3D space according to an optional and preferred embodiment of the present invention. FIG. 1D illustrate optional sudoku playing surfaces as is known and accepted in the art.

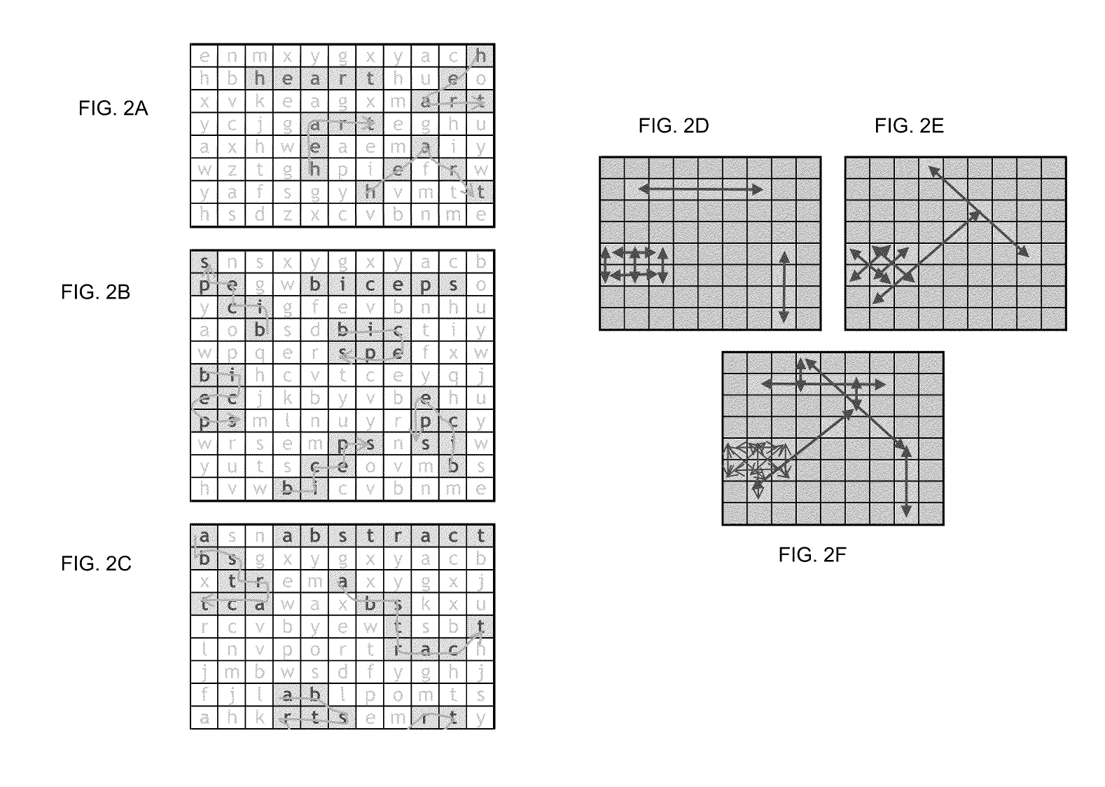

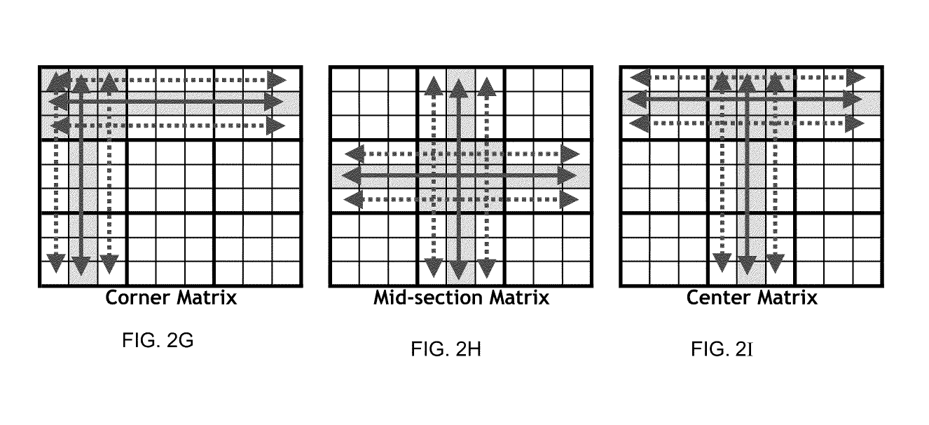

FIG. 2A to 2I illustrates optional directionality rules that may be applied to a given 2D game are shown by the arrows. Most preferably, directionality of play is optionally defined by a game's rules is transferable to 3D space according to the present invention. For example, FIG. 2B illustrates a word search puzzle directionality wherein the directionality allowed in the game, shown in arrows, provide for almost any direction of play and not necessarily in a traditional means as depicted in FIGS. 2D-2E for example.

FIG. 2G-2I illustrate the directionality of play used in a traditional 2D sudoku game. An optional embodiment according to the present invention, optionally transforms the directionality from the 2D realm to 3D space that most preferably also takes into account other game core aspects fore example including but not limited to rules and playing surface in 3D space.

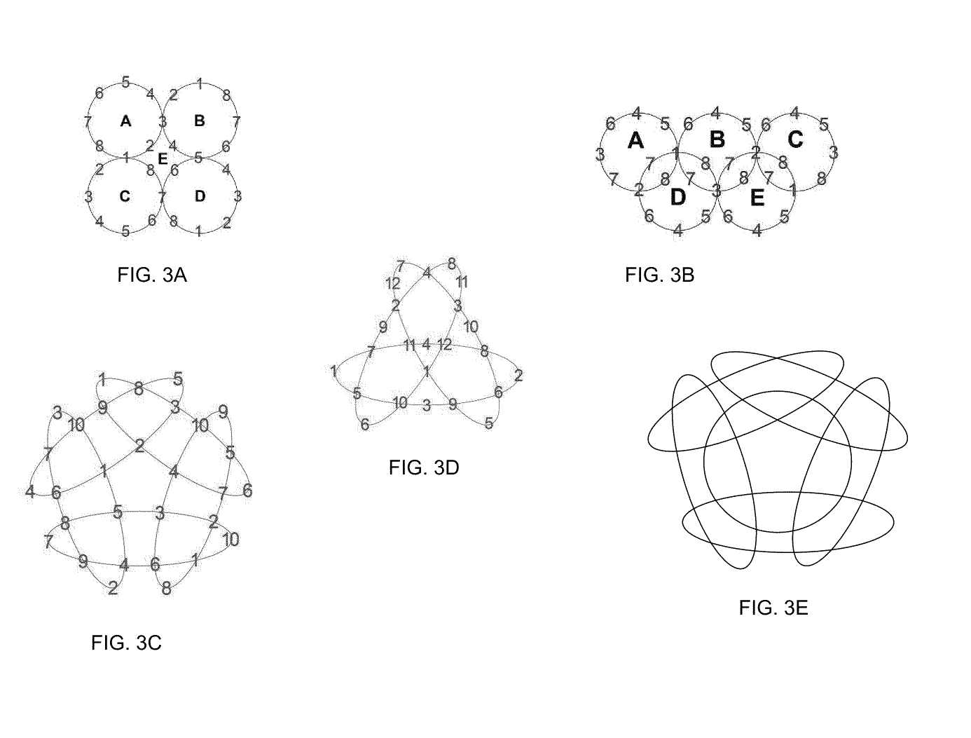

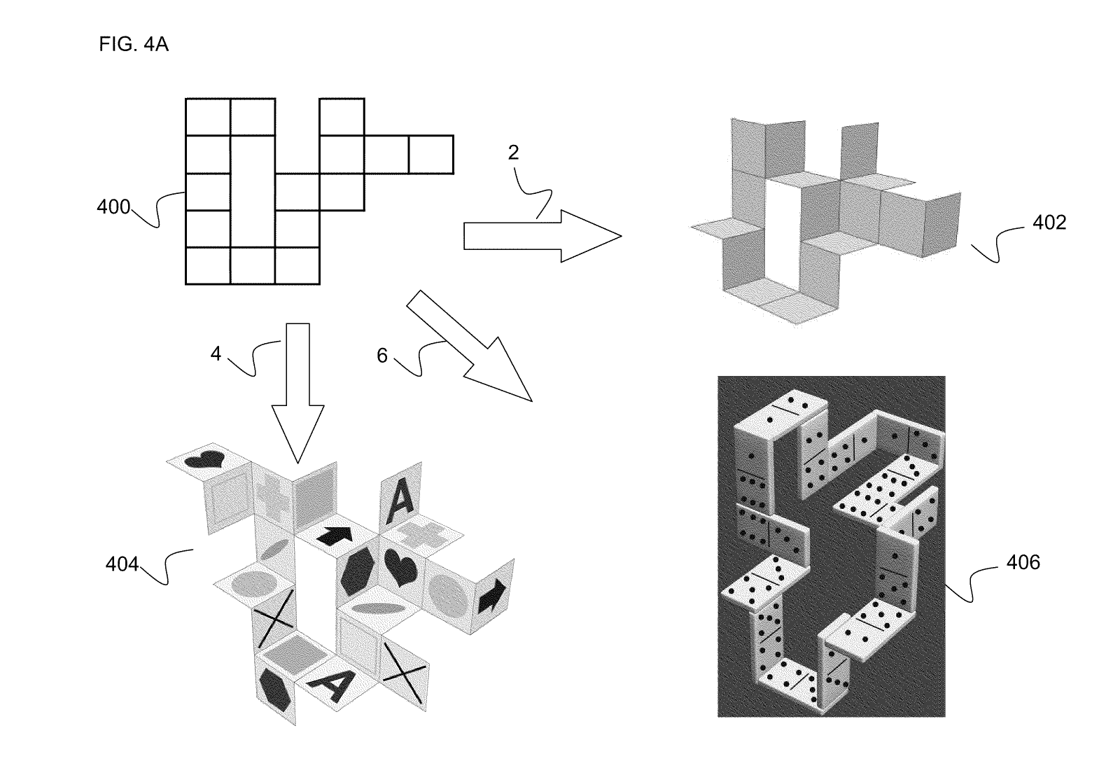

FIGS. 3A to 3E illustrate additional directionality options typically associated with 2D games that are spherical and optionally comprising overlap. For example FIG. 3A depicts circular directionality that define 5 areas within the playing area that do not overlap while FIG. 3B comprise an optional circular directionality with overlap therein defining different playing areas of the traditional 2D game. FIG. 3C and 3D depict ellipsoid directionality that may be incorporated into a 2D game that optionally requires specialized transformation to be implemented in 3D space. FIG. 3E depicts a mixed spherical directionality comprising both ellipsoids and circular structures that may optionally require specialized transformation into the 3D space.

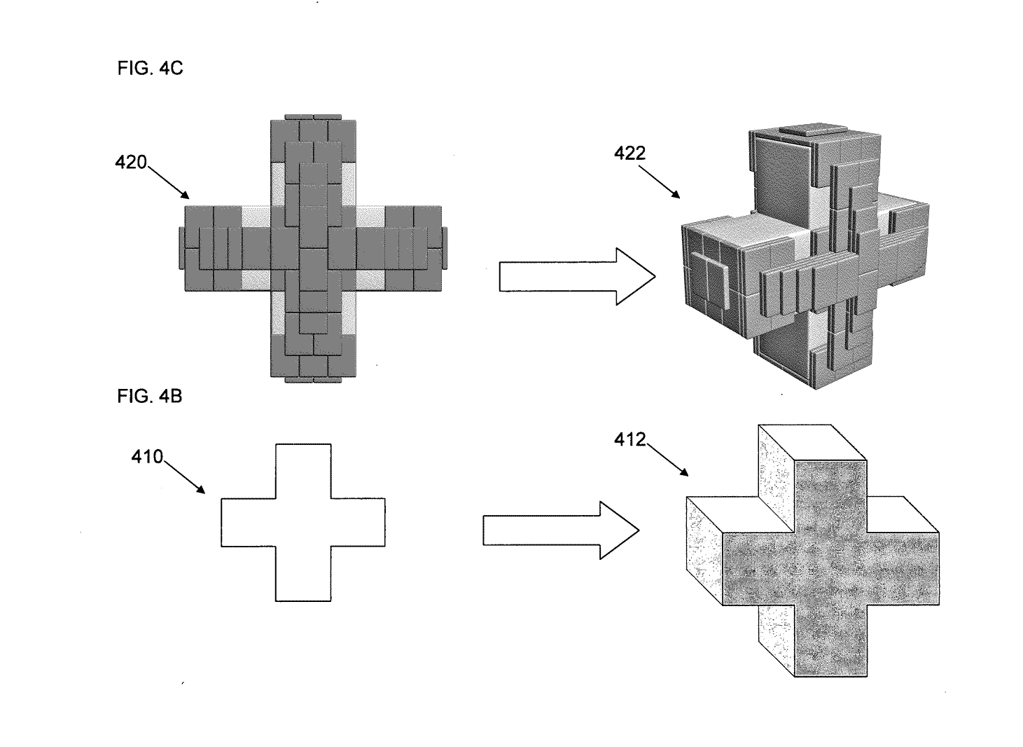

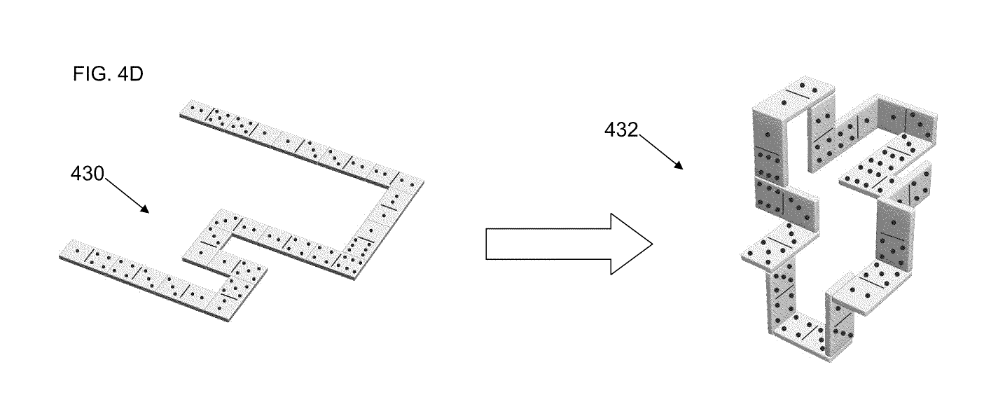

FIG. 4A depicts the transformation process according to an optional embodiment of the present invention wherein a 2D playing surface 400 is optionally converted to a variety of optional surfaces or games. For example, a transformation according to an optional embodiment of the present invention is illustrated by arrow 2 providing for the transformation of the playing surface 400 to 3D surface 402. Optionally a number of game types may be implemented on playing surface 402. Optionally and preferably the game implemented may be based on the additional core components utilized in the transformation. For example, playing surface 404 is optionally formed with an optional transformation 4 optionally comprising a plurality of core components for example a surface transformation and a game rule transformation, for example a memory or match game. For example, playing surface 406 is optionally formed with an optional transformation 6 according to an optional embodiment of the present invention comprising a plurality of core components for example a surface transformation and a game rule transformation, for example a dominos games. An optional embodiment of the present invention provides for a plurality of transformations, for example 2,4 or 6 that may transform a common playing surface, for example 400, into a plurality of different 3D games as optionally depicted in playing surfaces 402, 404, and/or 406.

FIGS. 4B, 4C and 4D depict a further optional transformation according to the present invention. For example, FIG. 4B depicts the transformation of the playing surface wherein a 2D playing surface 410 is transformed to a 3D playing surface therein redefining the game, optionally and preferably in term of the skills and/or cognitive process required to play the game. FIG. 4C depicts the same playing surface transformation as depicted in FIG. 4B as implemented with a game of Mahjong, for example. FIG. 4C shows traditional Mahjong comprising 2D planar playing surface 420 with interrelated stacked playing pieces 422. The transformation 424 according to an optional embodiment of the present invention coverts playing surface 420 to a 3D playing surface 426 preferably producing a new 3D depiction of the traditional 2D stacked playing surface and game. Playing surface 426 provides an additional dimension wherein the playing pieces 422 now interact with one another over a plurality of surfaces therein transforming the cognitive processes required to play the game. Most preferably, in order to properly play the Mahjong depicted by playing surface 426 a player would need to rotate, toggle, the playing surface in order to is allow for playing the game. Optionally, at least one or more of the rules of the games may be alerted to allow for 3D representation and/or transformation of the playing surface to facilitate playing the game.

FIG. 4D depicts a depicts the transformation of the two dimensional dominos playing surface 430 is transformed to preferably an equivalent three dimensional surface playing surface 432 therein redefining the game, optionally and preferably in term of the skills and/or cognitive process required to play the game. Optionally and preferably, playing surface 432 may be implemented in a open ended format, optionally in a growing and/or decreasing open ended games.

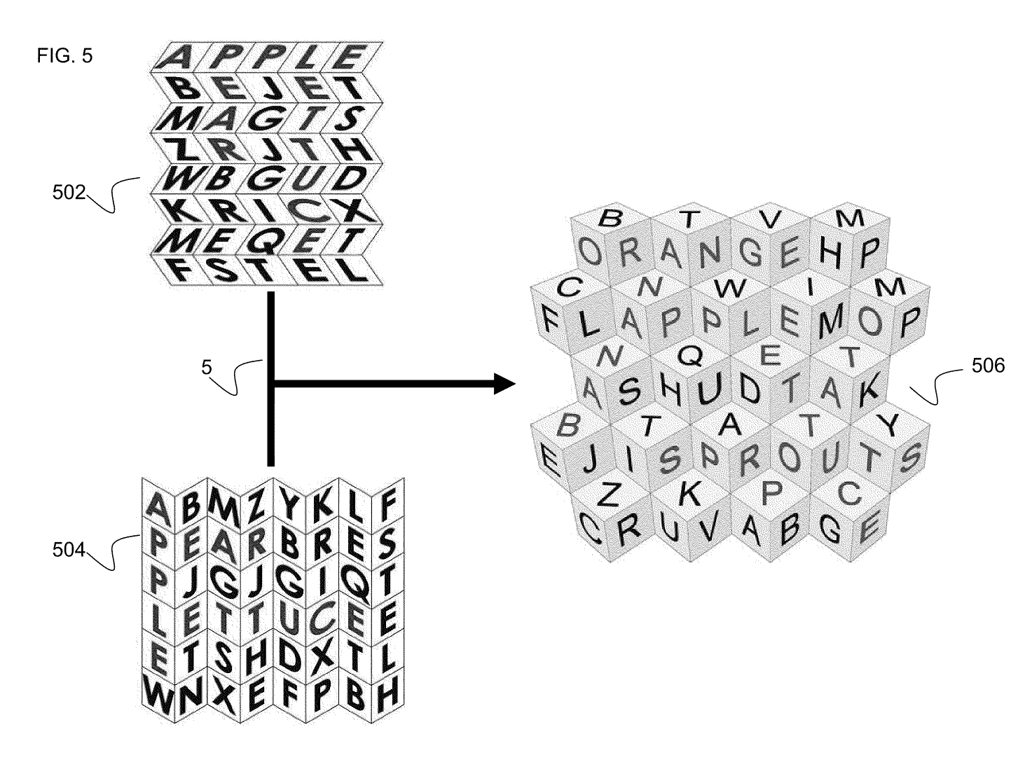

FIG. 5 illustrates an optional transformation according to an optional embodiment of the present invention of a planar word search playing surface (not shown) that optionally undergoes an initial transformation producing surfaces 502 and 504 that are optionally integrated by transformation arrow 5 to optionally form a cubic 3D playing surface structure 506 of the same game type.

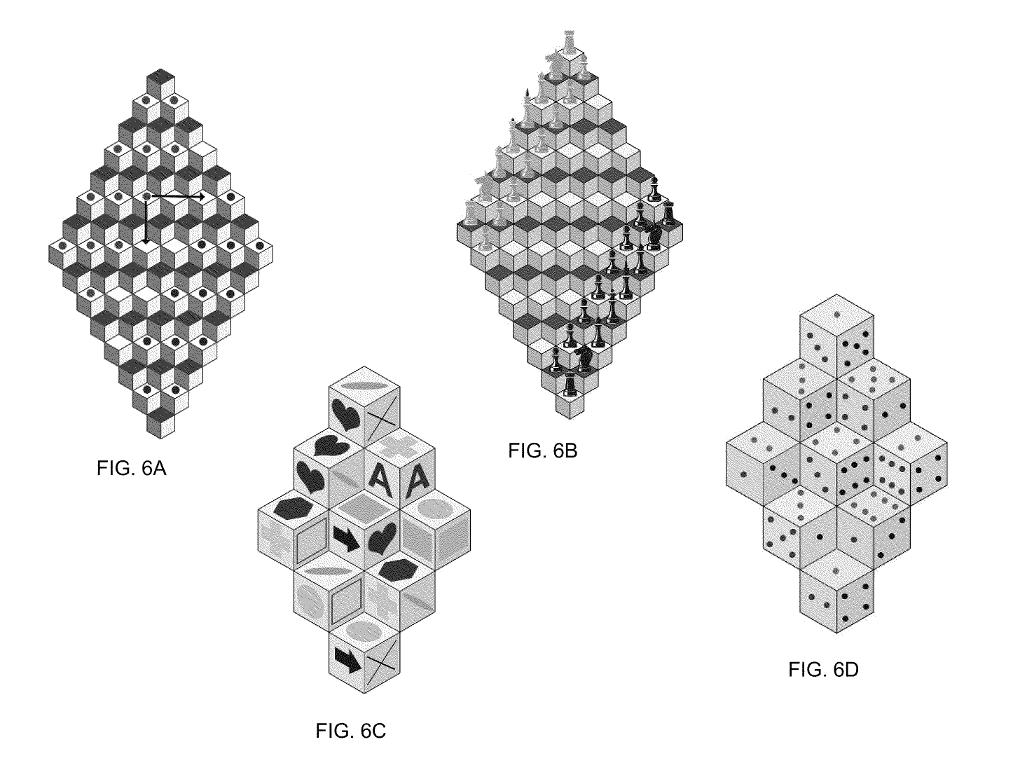

FIGS. 6A-D illustrate the product of optional 2D to 3D transformations producing an optional 3D cubic playing surface with optional game types. For example, FIG. 6A illustrates a checkers 3D cubic playing surface, wherein the rules transformed to suite the 3D space. For example, FIG. 6B illustrates a chess game in 3D space as transformed according to an optional embodiment of the present invention. FIG. 6C illustrates a memory and/or match game following a stacked cubic 3D transformation from the 2D playing surface, optionally as depicted in FIG. 5. FIG. 6D illustrates an optional 3D stacked cubic transformation according to the present invention of a dominos game.

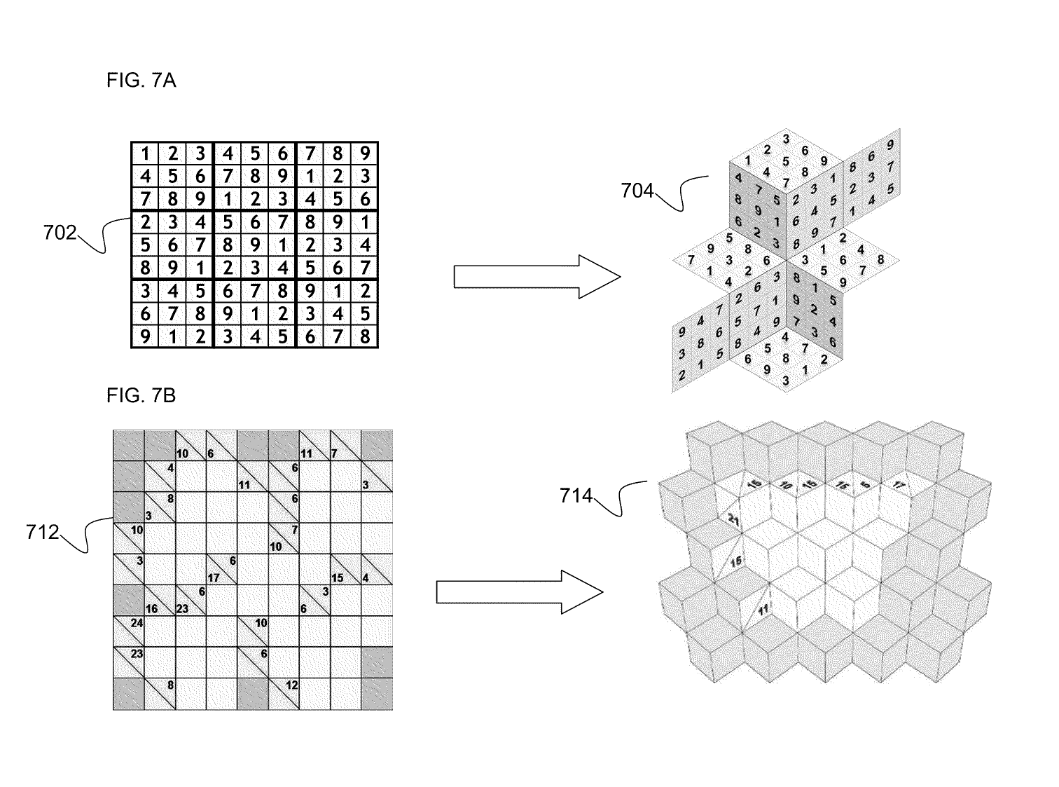

FIGS. 7A-B illustrate the product of optional 2D to 3D transformations according to the present invention. FIG. 7A illustrates a sudoku playing surface 702 that is transformed to form an optional 3D sudoku playing surface 704. FIG. 7B illustrates an optional transformation according to the present invention of a 2D kakuro playing surface 712 to a 3D stacked cubic playing surface 714. Most preferably, the rules for the games are also transformed to fit the 3D space.

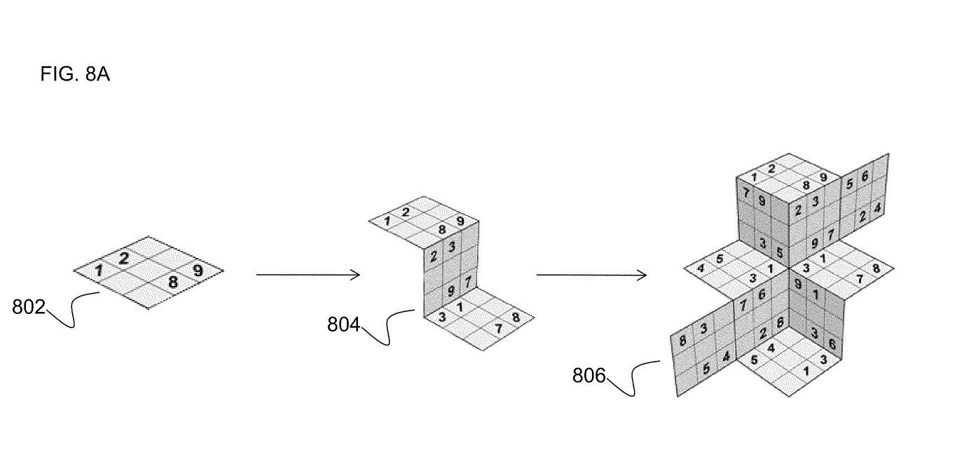

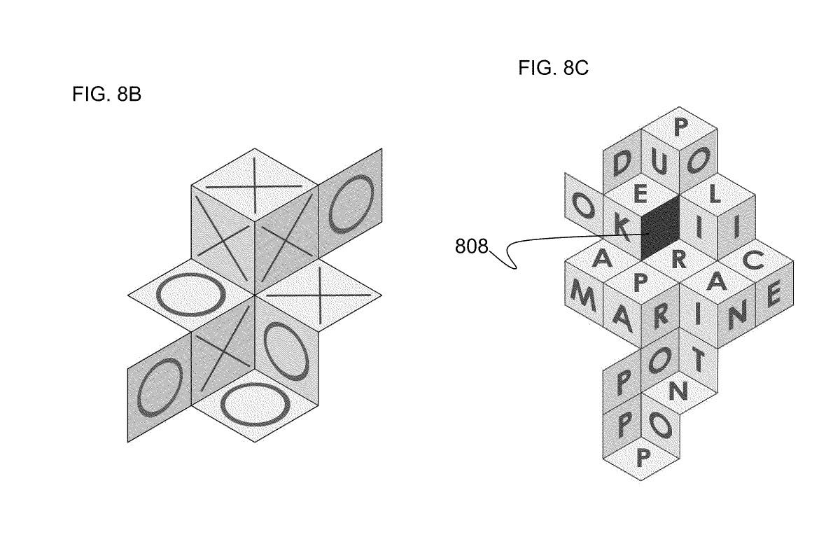

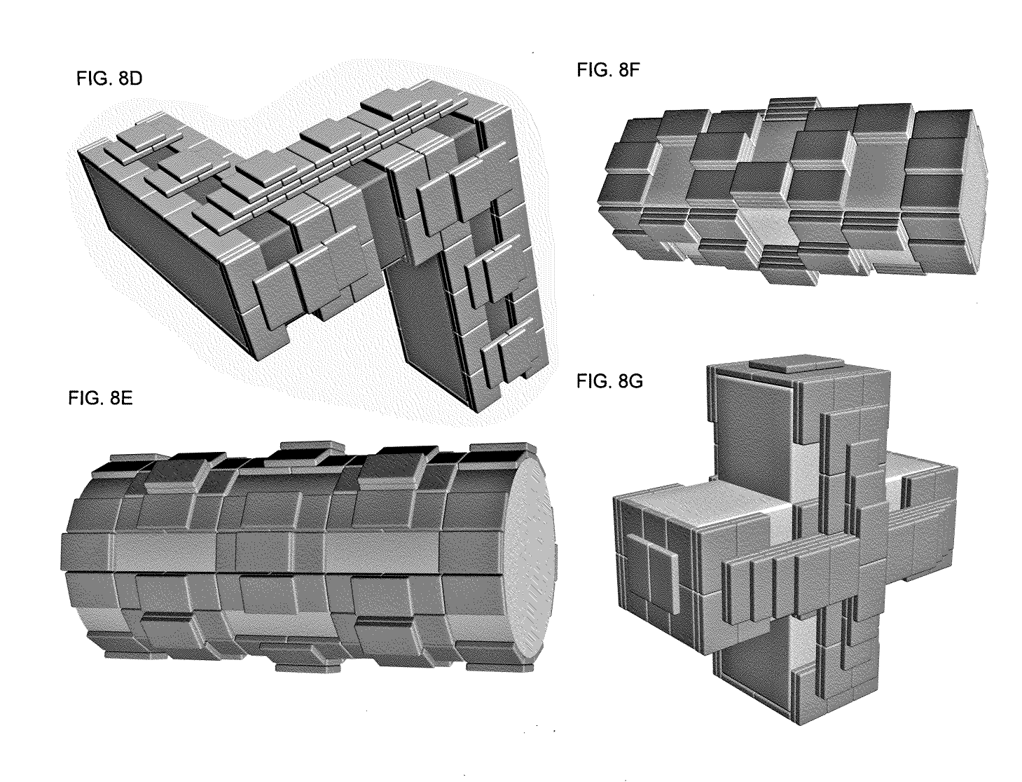

FIG. 8A depicts an optional transformation according to an optional embodiment of the present invention comprising a 2D playing surface 802 the is transformed into a 3D playing surface 804 that may optionally be compiled or integrated into an open ended playing surface illustrated in playing surface 806. Optionally surface 806 is open ended and interactive preferably allowing a user to continuously build on playing surface 806 therein interactively producing a more complicated playing surface.

FIG. 8B illustrates an optional playing surface following an optional open ended 3D transformation of a tic-tac-toe playing area. FIG. 8C illustrates an optional playing surface following an optional open ended 3D transformation of a cross word game. FIG. 8C further illustrates the results of the core components transformation wherein blank space 808 are integrated into the playing surface to properly transform the original 2D surface to the 3D space.

FIGS. 8D to 8G illustrate the product of optional 2D to 3D transformations according to the present invention on the playing surface of a traditional Mahjong playing surface, as described in FIG. 4C. FIG. 8G illustrates a 3D cross shaped Mahjong playing surface, wherein most preferably the transformed 3D playing surface must be rotated to allow proper play of the game. FIG. 8D illustrates a 3D “L” shaped Mahjong playing surface, wherein most preferably the transformed 3D playing surface must be rotated to allow proper play of the game. FIG. 8E illustrates a perspective view of a 3D cylindrical shaped Mahjong playing surface, wherein most preferably the playing surface must be rolled to uncover the full scope of the playing surface to allow the user to play the game. FIG. 8F illustrates a 3D tower shaped Mahjong playing surface wherein most preferably the transformed 3D playing surface must be rotated to allow proper play of the game.

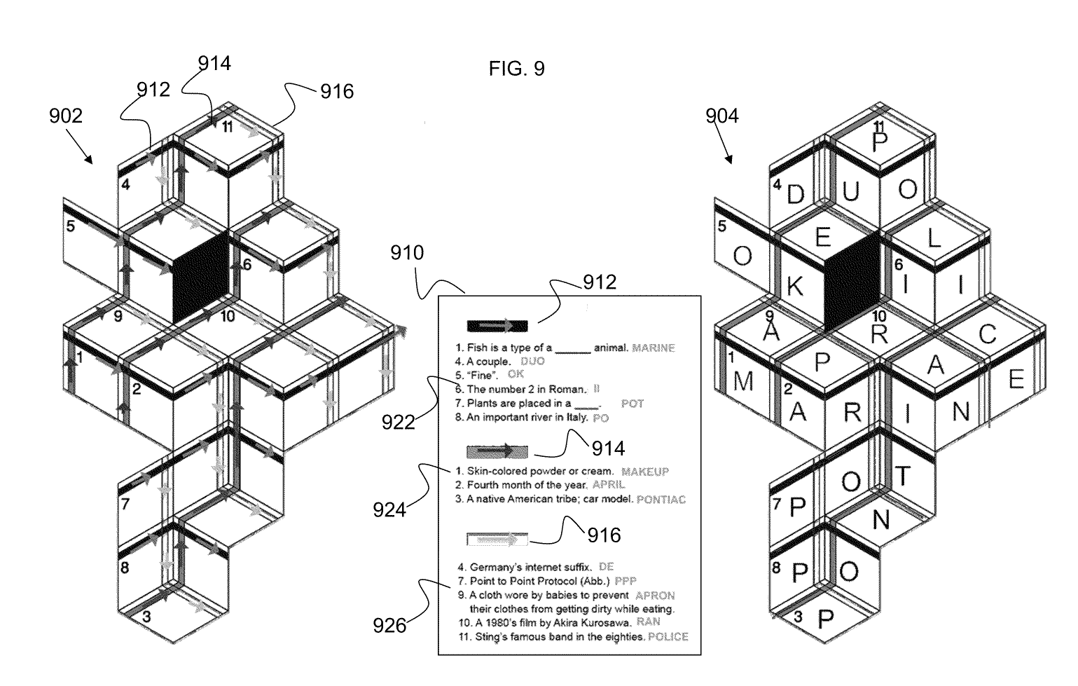

FIG. 9 illustrates an optional transformation according to an optional embodiment of the present invention where a crossword puzzle is transformed into the 3D space further comprise directionality arrows 912, 914, 916 (as depicted in FIG. 2) illustrated on surface 902 preferably account for transformed rules 922, 924, 926 in 3D space and providing direction to a user regarding the 3D transformation, allowing a user to solve the crossword as illustrated in surface 904.

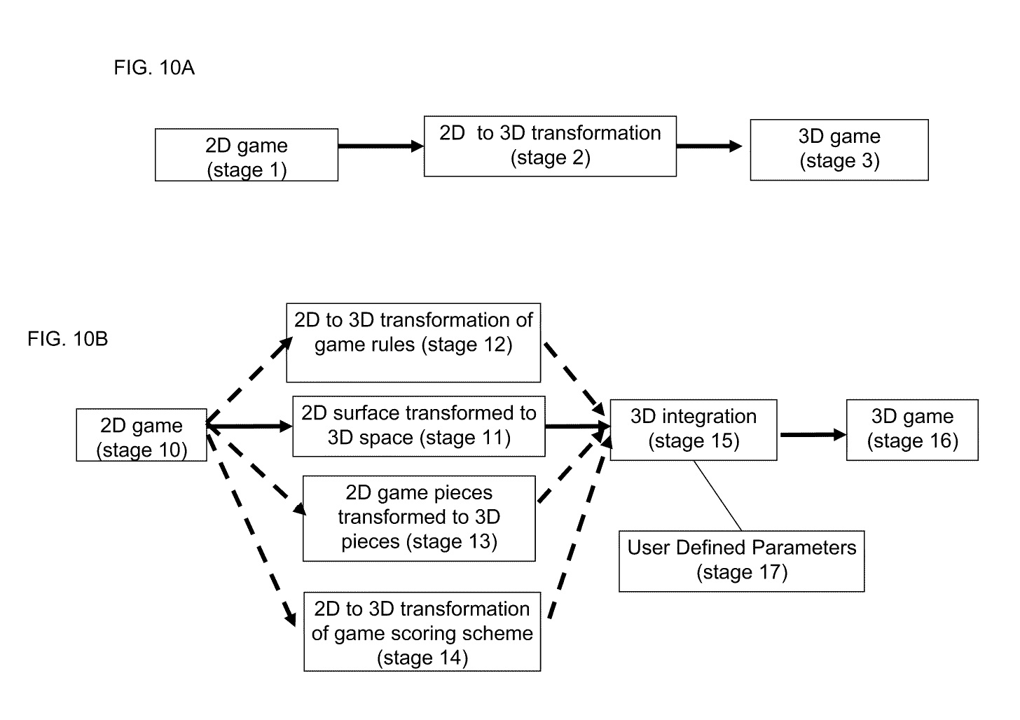

FIG. 10A shows a flowchart of an optional method according to the present invention wherein a 2D planar game is transformed to a 3D game according to the present invention. In stage 1 a 2D game for example including but not limited to sudoku, kakuro, checkers, crossword, word jumble, word search, tic-tac-toe, bingo, chess, dominos, puzzles, memory, backgammon, Go, Match 3, Mahjong, Chinese Mahjong or the like; is preferably analyzed, optionally and preferably to identify at least one or more core components for example including but not limited to game surface structure, game pieces, rules, scoring scheme or the like. In stage 2, the analyzed game undergoes transformation from 2D space to 3D space according to a preferred embodiment of the present invention. Preferably, at least one of the game's core components undergoes the transformations. Optionally, a plurality of game's core components undergo transformation. Following the transformation of at least one core component the 3D game is generated in stage 3.

FIG. 10B shows a flowchart of an optional method according to the present invention further expanding on stage 2 of FIG. 10A, showing optional stages in the transformation method, currently depicted in stages 11 to 15. Preferably, each of the game core components are identified and preferably analyzed in stage 10. In stages 11-14 individually identified core components for example including but not limited to playing surface, rules, game pieces, scoring scheme undergo individualized 2D to 3D transformation according to an optional embodiment of the present invention. Most preferably at least one core component is transformed. Optionally, a plurality of core components undergo individualized transformation process. Optionally, any combination of the transformed core components most preferably produces the optional 3D game according to the presenting invention. Most preferably, at least one core component, most preferably the playing surface, is included in the 3D transformed game according to an the present invention.

Optionally, in stage 11, the core component playing surface is preferably transformed from 2D space to a 3D space playing surface. Optionally, in stage 12, game rules are transformed into 3D space game rules. Optionally in stage 13, game pieces are transformed into 3D space game pieces. Optionally, in stage 14 the game's scoring scheme is transformed into 3D space scoring scheme.

In stage 15 the optional at least one or more, and most preferably a plurality of individual core component transformation are integrated to form a uniform 3D game in 3D space. Optionally, in stage 17 user defined parameters may be implemented or incorporated during the integration process. Optionally user defined parameters provide a user with the option of defining features required in the final process. User defined parameters optionally include but is not limited to type of game, open ended game, degree of difficulty, limited or expanded range of motion of the playing surface or the like parameters. In stage 16 the integrated 3D game is generated and outputted to at least one or more of a computer readable memory, a computer display device, a computer on a network, printout, or to user. Optionally, the integrated 3D game may be further enhanced or otherwise optimized to accommodate optional viewing platforms for example including but not limited to printed media, computerized display, mobile telephone display, PDA display, MP3 display or the like. Optionally varying shading and/or color schemes, for example grayscale, may be applied to a 3D playing surface display for optimizing the three dimensional visual effect for example on a digital display and/or print media. For example grayscale shading may be applied to a digital displays for example including but not is limited to PDA, MP3 player, MP4 player, touch-screen, mobile telephone, cellular telephone, game console, LCD, Plasma displays. For example grayscale shading may be applied to print media for example including but not limited to newsprint, books, magazine or the like, to enhance the perspective provided to the user.

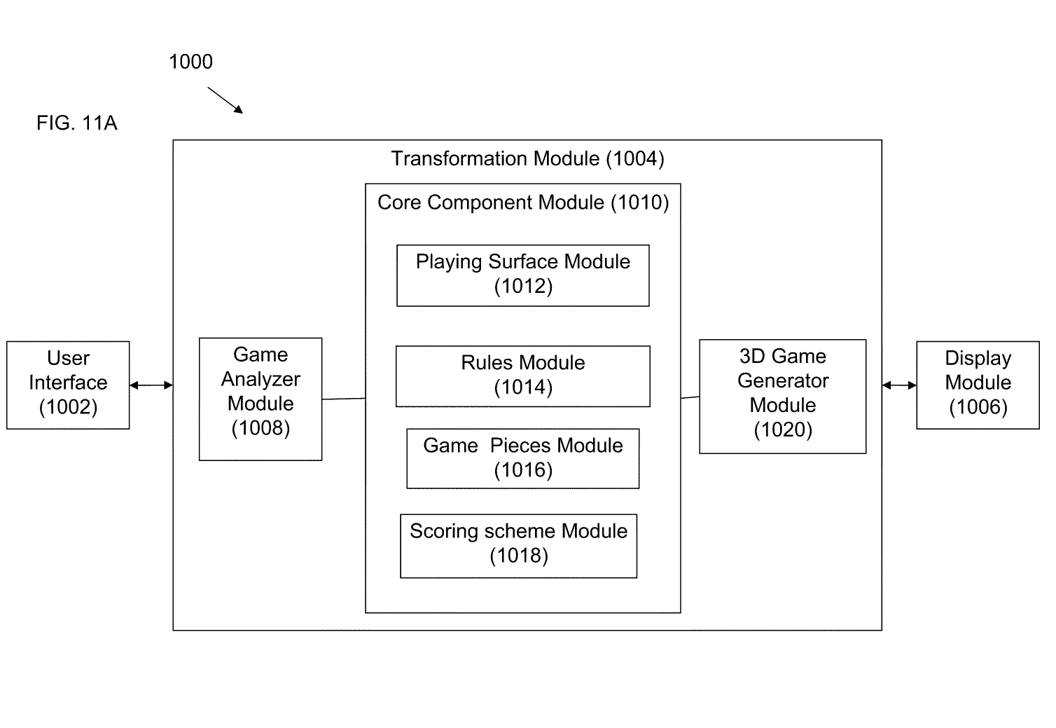

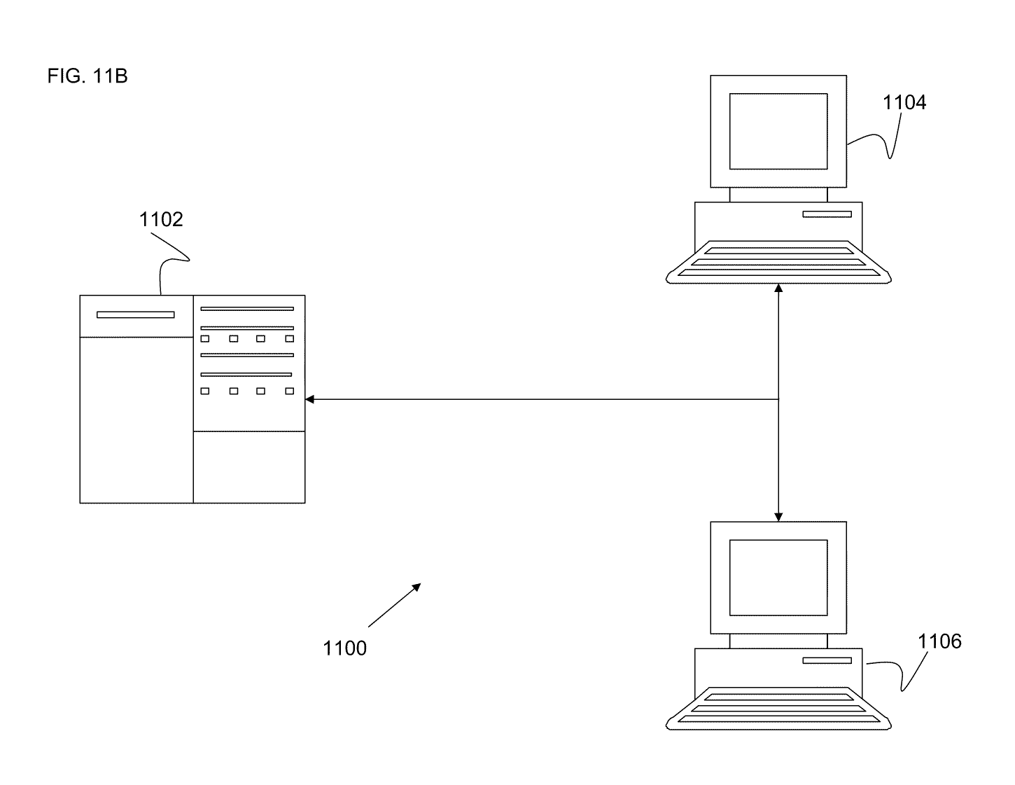

FIG. 11A shows an optional system 1000 according to an optional embodiment of the present invention for a two dimensional to three dimensional transformation of a playing surface. FIG. 11A depicts the optional system that may be used to implement the method previously described in FIGS. 10A-10B. System 1000 comprises a user interface 1002 for interacting with a user , a transformation module 1004 for transforming a 2D game to a 3D version of the game and a display module 1006. Optionally, user interface module 1002 may be provided in a plurality of forms for example including but not limited to screen, display, keyboard, speaker, scanner, camera or the like user interface as is known and accepted in the art. Optionally and preferably display module 1006 may optionally comprise a screen, display, printout, or the like display. Most preferably, transformation module 1004 provides for the transformation between a 2D game to a 3D version of the game, according to the present invention as described earlier in FIG. 10A.

Most preferably, transformation module 1004 comprises a game analyzer module 1008, core component module 1010 and a 3D generator module 1020. Optionally and preferably component module 1010 further comprises at least one and more preferably a plurality of sub modules for transforming the individual core components identified in the 2D game, preferably by game analyzer module 1008, to its 3D counterpart. Optionally and preferably component module 1010 comprises core component modules for example including but not limited to playing surface module 1012, rules module 1014, game pieces module 1016 and scoring scheme module 1018. Preferably at least one core component module is utilized to produce a 2D to 3D transformation. Most preferably, playing surface module 1012 may be used to convert the playing surface is included in the transformation process using within system 1000. Preferably and optionally rules module 1014 may be used to transform the rules of a playing surface from its 2D state to its 3D form, for example including any limitation and/or expansion of moves, scores or the like. Preferably and optionally game pieces module 1016 may be used to transform the playing pieces from its 2D state to its 3D form. Preferably and optionally scoring scheme module 1018 may be used to transform the scoring scheme from a 2D state to an equivalent 3D state.

Most preferably 3D Game Generator Module 1020 is utilized to integrate and the optional core component transformations to produce a cohesive and 3D game that may be displayed on display module 1006 and/or user interface 1002. Optionally, generator module 1020 may be used to individually interact with at least one or more of the various core component modules 1012-1018 to preferably ensure that a change is appropriately reflected in another. For example, a change in the playing surface due to user preferences communicated to playing surface module 1012 via user interface 1002 is correlated to corresponding adaptations in the games rules via rules module 1014. Optionally, generator module interacts with the core component module 1010 to bring about a similar integrative adaptation to account for a change in one core component of the game preferably in at least one and more preferably all core components of the game.

FIG. 11B depicts an optional system 1100 of an optional embodiment of the present invention comprising server 1102 and a plurality of client 1104 and 1106 most preferably connected over a network connection as is known and accepted in the art for example including but not limited to an internet connection or an intranet connection or the like. Optionally, server 1102 provides at least one and more preferably a plurality of clients 1104 and 1106 a 3D game according to the present invention. Optionally, server 1102 may comprise a social network providing at least one and more preferably a plurality of clients access to the 3D game transformation process according to the present invention. Optionally, a social network provides clients with an interactive common network based platform, for example allowing client to interact by including means as is known and accepted in the art to interact by way of email, chat, playing competitive game, idea exchange, customizing 3D games, creating 3D games or the like processes.

Optionally, the optional method depicted in FIGS. 10A and B may be implemented on system 1100. Preferably, server 1102 provides the platform wherein the transformation may take place. Optionally, the 2D source game may be optionally uploaded from at least one or more client 1104 or 1106 to server 1102, preferably using state of the art communication protocols over a network connection for example including but not limited to markup language, XML or the like. Preferably, server 1102 identifies the games core components, for example including but not limited to playing surface, rules, scoring scheme, game pieces, or the like. Preferably once core components are identified server 1102 performs the required transformation from 2D space to 3D space, most preferably to provide a comprehensive 3D game.

Most preferably, the comprehensive 3D game is then made available to a plurality of clients for example including clients 1104 and 1106 that may optionally play the game individually or optionally competitively against one another. Optionally, the produced 3D game may be communicated to client 1104 using state of the art communication protocols for example including but not limited to wired, wireless, cellular, optical, IR, RF or the like communication protocols known and accepted in the art. Optionally, the produced 3D game may be downloaded by client 1104 and or client 1106 over a network connection to a platform for example including but not limited to at least one or more of a computer readable memory, a computer display device, a computer on a network, printout, or to user. Optionally, the game may be played online or offline. Optionally, the 3D game may be further enhanced or otherwise optimized to accommodate optional viewing platforms for example including but not limited to printed media, computerized display, mobile telephone display, PDA display, MP3 display or the like.

While the invention has been described with respect to a limited number of embodiments, it will be appreciated that many variations, modifications and other applications of the invention may be made.

1. A method for converting a planar two dimensional game to a three dimensional game, the method being performed by a computer, the method comprising breaking down said two dimensional game to at least two or more core components that undergo a transformation to form a three dimensional depiction of said core components and wherein said core components are rebuilt into a game that is presented in three dimensional space;
and wherein said core components are selected from the group consisting of game playing surface, game rules, game scoring system, game playing pieces or a combination thereof.

2.-5. (canceled)

6. The method of claim 1 wherein said core components include game playing surface and game rules.

7. The method of claim 1 wherein said core component transformation is performed individually or uniformly to transform from two dimensional space to three dimensional space.

8. (canceled)

9. The method of claim 7 wherein said individually transformed core components are integrated to form said three dimensional game.

10. (canceled)

11. The method of claim 1 wherein said two dimensional game is chosen from the group consisting of sudoku, kakuro, checkers, crossword, word jumble, word search, tic-tac-toe, chess, dominos, puzzles, memory, backgammon, bingo, Go, Match 3, Mahjong, Chinese Mahjong.

12. (canceled)

13. The method of claim 1 wherein said three dimensional game is an open ended game based on traditional two dimensional games.

14. The method of of claim 1 wherein said three dimensional game is customized by incorporating user defined parameters variations to customized said three dimensional game wherein said user defined parameters are chosen from the group consisting of type of game, close or open ended game, degree of difficulty, limited or expanded range of motion of the playing surface or the like parameters.

15.-17. (canceled)

18. The method of claim 1 wherein said generated three dimensional game comprises a dynamic experience wherein optionally the user's viewing trajectory is toggled through the course of the game.

19. The method of claim 18 wherein said viewing trajectory is depicted automatically and/or manually by the group consisting the game, a user and/or third party.

20. The method of claim 1 implemented on a server connected to at least one and more preferably a plurality of clients through a network connection and wherein said three dimensional game is played on a platform chosen from the group consisting of an internet connection, intranet connection and social network.

21. (canceled)

22. The method of claim 1 wherein said game is implemented on a plurality of electronic mediums chosen from the group consisting of a PDA, server, computer, mobile telephone.

23. (canceled)

24. The method of claim 1 wherein said game is generated and outputted to at least one or more of a computer readable memory, a computer display device, a computer on a network, printout, or to user.

25. The method of claim 1 wherein said three dimensional game is further enhanced or otherwise optimized to accommodate optional viewing platforms chosen from the group consisting of printed media, digital media, computerized display, digital display, mobile telephone display, PDA display, game console, touch screen, LCD, MP3 and MP4.

26. (canceled)

27. A system for converting a planar two dimensional game to a three dimensional game comprising
a. a user interface for interacting with a user and for displaying said games, said user interface being operated by a computer; and
b. a transformation module for transforming said planar two dimensional game to said three dimensional game, said transformation module being operated by a computer and said transformation module comprising:
i. a game analyzer module for analyzing said planar two dimensional game; and
ii. a core component module for identifying and transforming core components of said two dimensional game including at least two or more sub-modules for transforming individual core components chosen from the group consisting of playing surface module, rules module, game pieces module and scoring scheme module; and
iii. three dimensional generator module for integrating said core components transformation into said three dimensional game;
c. and a display module for displaying said three dimensional game on a viewing platform and further enhanced or otherwise optimized to accommodate said viewing platform; wherein said viewing platform is selected from the group consisting of printed media, digital media, computerized display, digital display, mobile telephone display, PDA display, game console, touch screen, LCD, MP3 and MP4.

28-33. (canceled)

34. The system of claim 27 wherein said at least two sub-modules are said playing surface module and rules module.

35.-38. (canceled)

39. The system of claim 27 wherein said game is chosen from the group consisting of sudoku, kakuro, checkers, crossword, word jumble, word search, tic-tac-toe, chess, dominos, puzzles, memory, backgammon, bingo, Go, Match 3, Mahjong and Chinese Mahjong.

40.-42. (canceled)

43. The system of claim 27 wherein said three dimensional generator further comprises user defined parameters' module wherein said user defined parameters' module are chosen from the group consisting of type of game, close or open ended game, degree of difficulty, limited or expanded range of motion of the playing surface.

44.-46. (canceled)

47. The system of claim 27 wherein said generated three dimensional game comprises a dynamic experience wherein optionally the user's viewing trajectory is toggled through the course of the game and wherein said viewing trajectory is depicted automatically and/or manually by the group and/or third party.

48. (canceled)

49. The system of claim 27 wherein said three dimensional game is implemented on a server connected to at least one and more preferably a plurality of clients through a network connection.

50. The system of claim 49 wherein said three dimensional game is played on a platform chosen from the group consisting of an internet connection, intranet connection and social network.

51-54. (canceled)
